(19) United States
(12) Patent Application Publication
(10) Pub. No.: US 2004/0222097 A1
(43) Pub. Date: Nov. 11, 2004

(54) Channelled cassette for gel electrophoresis

(76) Inventors: Francis H. Koh, Potomac, MD (US); Chong S. Koh, Potomac, MD (US)

Correspondence Address: Francis H. KoH, 8811 Falls Road, Potomac, MD, 20854, US

(21) Appl. No.: 09/760,239

(22) Filed: Jan. 13, 2001

Related U.S. Application Data
(63) Continuation-in-part of application No. 09/524,567, filed on Mar. 13, 2000, now abandoned.

(51) Int. Cl. G01N 27/27; G01N 27/453

(52) U.S. Cl. 204/465; 204/615; 204/620

(57) ABSTRACT

The present invention comprises gel cassettes comprising a base plate with channels to retain gels and an outer plate removably attached to the base plate to form closed chambers within the gel cassette. A gel is disposed within the cassette and subsequently eluted to resolve various samples loaded within each chamber. The outer plate is removed and the gel columns are exposed along the open face regions of the channels of the base plate. The gels are developed within the channels of the base plate as developing solutions communicate with the gel to form an image thereon.

The present invention comprises a cassette assembly comprising a base plate with channels to retain gels and an outer plate removably attached to the base plate to form closed chambers within the gel cassette. A disposed gel is disposed within the cassette and subsequently eluted to resolve various samples loaded within each chamber. The outer plate is removed and the gel columns are exposed along the open face regions of the channels of the base plate. The gels are developed within the channels of the base plate as developing solutions communicate with the gel to form an image thereon.

### FIELD OF INVENTION

The present invention relates to a gel cassette and method of using the gel cassette in the field of electrophoresis where the present invention retains a polymerized gel within the cassette during the gel development stage.

### BACKGROUND OF THE INVENTION

By the use of gel electrophoresis methods and devices, various molecular species such as proteins and deoxyribonucleic acids (DNA) can be separated by charge and molecular weight. Gels in the form of slab or tube are often polymerized within single chamber cassettes formed by two plates assembled together with spacers in between to form a void volume therein. Sample molecular species are loaded into loading wells on gel slabs or tubes and are separated during the gel elution stage where a buffer solution moves across the gel matrix carrying samples to varying distances. Subsequently, the gels are developed by several conventional staining methods such as silver stains, negative stains, fluorescent stains, coomassie stains, IEF stains, blotting stains, and nucleic acid stains. These stains are used to visualize the migration of resolved species. The staining or dyeing processes require the exchange of solutions according to different development stages. A typical silver stain development of a gel involves a fixing stage, staining stage, and a stopping stage. During the development stages, the gels are removed from the cassettes and treated in their naked condition. The gels, being composed of polyacrylamide or other conventional polymeric material, are fragile and require care in handling especially for low percentage polyacrylamide or agarose gels. Current gel cassettes are made only for the gel elution stage, whereafter, the gel is removed from the cassette and developed separately as a naked gel placed inside containers having appropriate fluids. Current gel cassettes as claimed by U.S. Pat. No. 5,228,970 (Foley), U.S. Pat. No. 5,149,417 (Foley et al.), U.S. Pat. No. 4,929,329 (Danby et al.), U.S. Pat. No. 6,001,233 (Levy), U.S. Pat. No. 5,888,369 (Tippins et al.), U.S. Pat. No. 5,882,495 (Garrels), U.S. Pat. No. 4,417,967 (Ledley), U.S. Pat. No. 5,685,967 (Manis et al.), and U.S. Pat. No. 6,013,165 (Wiktorowicz et al.) comprise basically two flat plates secured to each other with spacers in between as to form a void volume for housing a gel. These references as well as WO9301491 (Boquet et al.) are hereforth incorporated by reference in their entirety. Many problems exist with developing naked gels. The fragileness of gels make it easy to damage them during processing. Additionally, keeping naked gels separate during development limits the quantity of gels that can be simultaneously developed. Furthermore, naked gels that move around during gel development make it difficult to visually monitor. What is clearly needed is a gel retaining cassette that can be used for the elution stage and thereafter developed within the cassette during the gel development stage as to minimize direct handling of the gel and to increase the throughput potential of gels.

### SUMMARY OF THE INVENTION

The present invention comprises a gel cassette having channels formed on the base plate or extruded as a single piece as the base plate wherein a gel is retained while exposed to fluids along the open face regions. These channels are parallel to one another and extend longitudinally across the base plate for a substantial length of the base plate. The gel is initially disposed into the gel cassette with the outer plate removably secured to the base plate, thereby covering the open face regions of the channels and forming closed chambers running parallel to each other between the base plate and the outer plate. The opening at the bottom end of the chamber is sealed while the opening at the top is open to receive a polymerizing gel solution. A void volume is left at the top of each chamber allowing a sample to be loaded above the polymerized gel. After the samples are loaded into the chambers, the secured cassette assembly is placed within a gel elution system and the samples are eluted and resolved across the gel. Thereafter, the adhesive material, which attaches the outer plate to the base plate, is removed, thereby exposing the base plate with gels retained within each channel yet exposing the gels along the open face regions. Developing solutions communicate with the gel through open face regions while being stabilized within the confines of the channels of the cassette thereby minimizing the risk of damaging the gels and increasing the throughput potential.

### DESCRIPTION OF THE FIGURES

FIG. 1 shows a plan view of a certain preferred embodiment of the present gel cassette invention.

FIG. 2 shows a top view of the gel cassette where the outer plate 2 is detached from the T rails 7.

FIG. 3 shows a top view of the gel cassette where the outer plate 2 is secured to the base plate thereby forming closed chambers 6 which are formed by the void space created the T rails and the secured outer plate over the T rails.

FIG. 4 shows a plan view of another preferred embodiment wherein a separating mid section 8 forms two regions of chambers on the gel cassette.

FIG. 5 shows a close up of an indent cavity 9 formed on the base plate between two T rails.

FIG. 6 shows a cut away profile view of a T rail having an opening 10.

FIG. 7 shows possible positions of these T rail openings, the left displaying openings in a horizontal position and the right displaying a diagonal arrangement.

### DETAILED DESCRIPTION OF THE PREFERRED EMBODIMENTS OF THE INVENTION

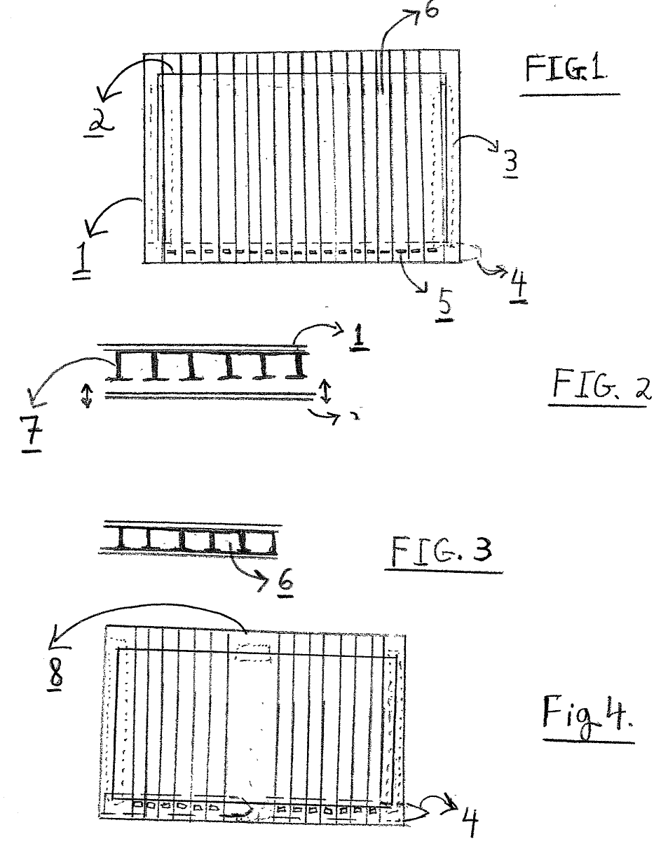

In a certain preferred embodiment as shown in FIG. 1, the get cassette of the present invention comprises a base plate 1 having channels with an open face region whereupon an outer plate 2 is removably secured to the base plate 1 by adhesives 3, thereafter forming closed chambers 6 in the void space between the base plate and the outer plate 2. The channels can be formed by attaching T rails 7 onto the base plate or forming the channels and the base plate as a single solid piece by an extrusion process. The channels can also be formed by attaching rail blocks to the base plate and subsequently attaching flat plates to the raised blocks to form a T rail. Alternatively, the rail blocks may be extruded as a single piece with the base plate to which the flat plates can be subsequently attached. FIG. 2 shows the cassette of FIG. 1. wherein the outer plate 6 is detached from the base plate thereby showing the channels having an open face region.

FIG. 3 shows the same cassette wherein the outer plate 2 is secured to the base plate 1 forming closed chambers therein. A gel polymerizing solution is disposed within the closed chamber through an opening on the top while an adhesive or sealing material shown in 4 of FIG. 1 seals the opening 5 at the opposite end of the chamber.

In another preferred embodiment shown in FIG. 6, the T rails have an opening 10 that allows the disposed gel polymerizing solution to flow and communicate between the closed chambers. In yet another further preferred embodiment shown in FIG. 5, the base plate 1 has indention cavities 9 which serve to prevent a subsequently polymerized gel from moving or sliding within the channel during agitation or processing of the gel.

In another certain preferred embodiment shown in FIG. 7, the T rail openings 10 are positioned in a horizontal manner or in a diagonal manner.

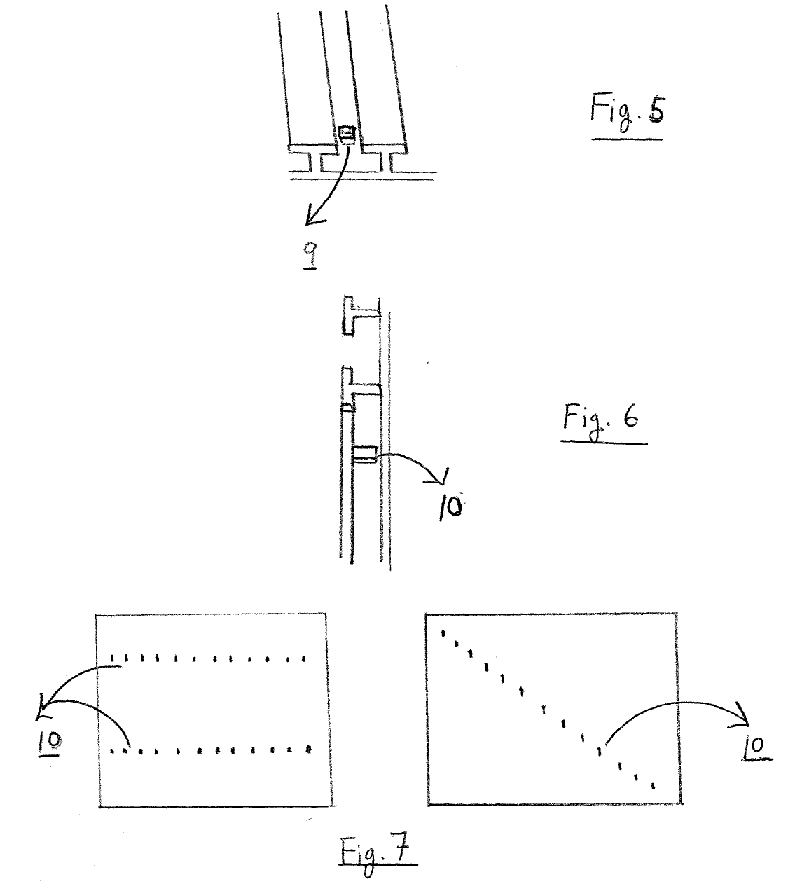

In still another preferred embodiment shown in FIG. 4, the base plate 1 is divided into two channel regions along a mid dividing section 8, which allows the outer plate to be removably secured along the mid section 8 as well as the peripheral edges where the outer plate 2 meets or contacts the base plate 1 as shown in by the position of the adhesive 3 of FIG. 1.

A typical use of any of the above mentioned embodiments involves disposing a polymerizing solution into the closed chambers and thereafter forming separate sample running lanes within each chamber. Each chamber becomes a miniature gel column where samples can be loaded above and resolved through the gel medium during gel electrophoresis (gel elution stage). Subsequently, the outer plate is removed and the gel columns are exposed along the open face regions of the base plate. However, the gels are retained within each individual channel. This cassette with gels retained within, are exposed to developing solutions that communicate with the gel and form an image thereon. The appropriate stopping solutions are applied and images are formed on the gel within the base plate of the gel cassette. The resulting gels can be photographed or sealed and dried. Because developing gels within the cassettes of the present invention protects actual gels from physical damage, many cassettes can be used to develop gels simultaneously, thereby increasing the throughput potential of gel development.

The cassettes of the present invention can be made of plastic, plastic composites, polymers, glass, or other suitable rigid materials. Adhesive materials can be tape, elastic compounds, clamps or other fastening devices. Suitable adhesives may be epoxy resins, silicone based or other polymer based adhesives.

Variations in the material as well as the size, shape or positioning of the elements are within the scope of the present invention. The embodiments of the present invention can be used for precast gels or casting gel systems such as multi-cast systems.

What is claimed:

1. A cassette comprising:
a. a base plate having vertical channels formed thereon wherein the vertical channels have open face regions;
b. an outer plate removably secured and proximate to the base plate thereby covering the open face regions and forming closed chambers wherein a gel is to be disposed or casted within and whereupon removal of the outer plate, the vertical channels retain the gel while exposing the gel along the open face regions.

2. The cassette of claim 1, wherein said cassette is composed of a material selected from glass, plastic, or other polymer composite material.

3. The cassette of claim 1, wherein said outer plate is removably secured to the base plate along the peripheral edges of the outer plate where the outer plate meets the base plate using adhesive material or clamping device.

4. The cassette of claim 1, wherein said closed chambers have openings at opposite ends.

5. The cassette of claim 1, wherein said closed chambers have openings between chambers thereby allowing the polymerizing gel solution disposed inside the chambers to communicate between chambers.

6. The cassette of claim 1, wherein said base plate has along the surface of the channel, indent cavities wherein a gel can polymerize therein.

7. The cassette of claim 1, wherein said channels are formed from a solid base plate having void spaces running the length of the base plate.

8. The cassette of claim 1, wherein said channels are formed by raised T columns fixed upon the base plate and running parallel from one another.

9. The cassette of claim 8, wherein said T columns are extruded and formed as a solid piece with the base plate.

10. The cassette of claim 8, wherein said T columns are formed from column blocks, raised from the base plate and made as a solid piece with the base plate or attached to the base plate, where flat plates are attached to the column blocks.

11. A method of using a cassette comprising the steps of:
a. placing an outer plate on the surface of a base plate having vertical channels with open face regions;
b. securing the outer plate to the base plate with an adhesive material or clamping device thereby forming a sandwich and closing the open face regions to form closed chambers between the outer plate and the base plate except for the opening at opposite ends of each chamber; and
c. sealing the exit openings with removable adhesive material or clamp device thereby readying the gel cassette to receive a gel polymerizing solution within the closed chambers.

12. The method of claim 11, wherein a gel polymerizing solution is poured into the closed chambers and thereafter polymerizing to form gel columns with sufficient void volume at the top to load samples within each gel column.

13. The method of claim 12, wherein said samples for gel electrophoresis separation are loaded into said chambers of the cassette.

14. The method of claim 13, wherein said cassette with loaded samples are inserted into an elution system thereby resolving the loaded samples through the gel columns.

15. The method of claim 14, wherein said cassette after gel elution, is removed from the elution system and the outer plate is removed from the base plate thereby opening the chamber and exposing the gel columns along the open face regions of the channels.

16. The method of claim 15, wherein said cassette with open face regions exposing the gel columns are treated with an image developing solution.

17. The method of claim 16, wherein said developing solution communicates with the gel columns through the open face regions along the channels thereby forming an image on the gel and subsequently treating said cassette with fixing solution.
